(19) United States
(12) Patent Application Publication
(10) Pub. No.: US 2020/0039801 A1
(43) Pub. Date: Feb. 6, 2020

(54) SUPPORT

(71) Applicant: Miro Industries, Inc., Heber City, UT (US)

(72) Inventors: Nathan M. Sargent, Heber City, UT (US); Kael Berkley, Heber City, UT (US); Brigham Watt, Heber City, UT (US); Erica Straddeck, Heber City, UT (US); Robb Neal Davis, Orem, UT (US)

(21) Appl. No.: 16/056,190

(22) Filed: Aug. 6, 2018

(51) Int. Cl. B66F 3/08; E04G 23/06; E04G 21/16; E04G 11/36

(52) U.S. Cl. CPC B66F 3/08; E04G 23/065; B66F 2700/04; E04G 11/36; E04G 21/163

(57) ABSTRACT

A floor jack may include a base, and a threaded pillar threadingly coupled to the base. The threaded pillar may include a dome top surface. The floor jack may also include a pedestal. the pedestal may include concave portion, and the concave portion may include a mating curvature relative to the dome top surface of the threaded pillar.

### BACKGROUND

Many architectural elements such as pipes, heating, ventilation, and air conditioning (HVAC) systems and other utilities may be incorporated underneath an overlaying floor. The overlaying floor may include raised flooring elements such as pavers or tiles incorporated into commercial and residential properties to ensure that these utilities are protected from weather, and provide a leveled or sloped overlaying floor with respect to an intended orientation, or maintained in and intended position. For example, flooring may be raised or elevated from a sub-floor to provide a level surface and access to utilities that may be placed under the raised flooring. The raised flooring may be utilized in patios, walkways, decks and other architectural elements. Further, these architectural elements may be located within a structure such as a building either on rooftops or at grade.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is an isometric view of a support, according to an example of the principles described herein.

FIG. 2 is an isometric, exploded view of a support, according to an example of the principles described herein.

FIG. 3 is a perspective view of a base of a support, according to an example of the principles described herein,

FIG. 4 is a top plane view of a base of a support, according to an example of the principles described herein.

FIG. 5A is a side plane view of a base of a support, according to an example of the principles described herein.

FIG. 5B is a side plane view of the base of the support within circle A of FIG. 3A, according to an example of the principles described herein.

FIG. 6 is a side cutaway view of a base of a support, according to an example of the principles described herein.

FIG. 7 is an isometric view of a threaded pillar of a support, according to an example of the principles described herein.

FIG. 8 is top plane view of a threaded pillar of a support, according to an example of the principles described herein.

FIG. 9 is side plane view of a threaded pillar of a support, according to an example of the principles described herein.

FIG. 10 is side cutaway view of a threaded pillar of a support, according to an example of the principles described herein.

FIG. 11 is an isometric view of a set coupler of a support, according to an example of the principles described herein.

FIG. 12 is top plane view of a set coupler of a support, according to an example of the principles described herein.

FIG. 13A is side plane view of a set coupler of a support, according to an example of the principles described herein.

FIG. 13B is side cutaway view of a set coupler of a support, according to an example of the principles described herein.

FIG. 14 is an isometric bottom view of a pedestal of a support, according to an example of the principles described herein.

FIG. 15 is isometric top view of a pedestal of a support, according to an example of the principles described herein.

FIG. 16 is bottom plane view of a pedestal of a support, according to an example of the principles described herein.

FIG. 17 is side plane view of a pedestal of a support, according to an example of the principles described herein.

FIG. 18 is side cutaway view of a pedestal of a support, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Support pedestals provide a way to create raised flooring over an underlying subfloor such as concrete, creating a hollow space underneath the raised flooring that may serve, in an example, as a walking surface. This hollow space can contain the utilities, incorporating elements such as a sloped underlying substrate while maintaining a level floor surface by virtue of the support pedestals. Support pedestals may adjust in angle, orientation, and height to conform to desired configurations. In addition to being used to support tile or pavers to form a raised floor, the pedestals may also be used to support wood or trek deck systems.

Thus, some roof structures or flooring may be elevated and supported by the support pedestals to assist in the leveling of the flooring system and allow for the replacement of individual flooring elements such as tiles or pavers. For example, a raised floor system may be used where it is desirable to maintain ready access below the floor surface to cables, wiring, ducting, and other building services and utilities. A raised floor system may include a plurality of floor panels that are supported a short distance above a base or subfloor by support members. The floor panels form a raised floor enclosing a space between the raised floor surface and the subfloor. The space can be used for the distribution of air, ductwork, electrical wiring, communication wiring, and computer cables, as well as many other utility infrastructure elements. Each panel, tile, or paver may be individually removable for easy access to the services below and to allow quick, low-cost relocation of service outlets.

Examples described herein provide a floor jack. The floor jack may include a base, and a threaded pillar threadingly coupled to the base. The threaded pillar may include a dome top surface. The floor jack may also include a pedestal. The pedestal may include a concave portion, and the concave portion may include a mating curvature relative to the dome top surface of the threaded pillar.

Leveling of an article placed on the floor jack is achieved through the relative articulation of the concave portion of the pedestal to the dome top of the threaded pillar. Further, the floor jack may include at least one fluid aperture to allow fluid to escape an interior of the base. The dome top may include at least a portion of a surface of a sphere. The threaded pillar may include a number of protrusions to facilitate the turning of the threaded pillar relative to the base to engage the threads of the threaded pillar and mating threads of the base. Turning of the threaded pillar relative to the base adjusts the height of the floor jack.

The floor jack may include a set coupler threadingly coupled to the threaded pillar. The set coupler sets the engagement of the threaded pillar relative to the base. The set coupler may include a number of flanges to facilitate in rotation of the set coupler about the threaded pillar. The pedestal may include a number of datum to align substrates placed on the pedestal. The base may include a length of piping coupled between the base and the set coupler.

Examples described herein also provide a support. The support may include a base. The base may include a threaded interior channel. The support may also include a threaded pillar. The threaded pillar may include a threaded exterior cylinder to threadingly couple to the base, and a domed top. The support may also include a pedestal including a concave portion. The concave portion may include a mating curvature relative to the dome top of the threaded pillar. Further, the support may include a set coupler threadingly coupled to the threaded pillar.

The set coupler sets the engagement of the threaded pillar relative to the base based on the location of the set coupler along the length of the threaded exterior cylinder of the threaded pillar. The relative articulation of the concave portion of the pedestal to the dome top of the threaded pillar levels an article placed on the support. The support may include a length of piping coupled between the base and the set coupler. The dome top may include at least a portion of a surface of a sphere. The threaded pillar may include a number of protrusions to facilitate the turning of the threaded pillar relative to the base to engage the threads of the threaded pillar and mating threads of the base. Turning of the threaded pillar relative to the base adjusts the height of the support. The set coupler may include a number of flanges to facilitate in rotation of the set coupler about the threaded pillar. The pedestal may include a number of alignment protrusions to align substrates placed on the pedestal. The base may include a number of anchor voids to anchor the base to a surface.

As used in the present specification and in the appended claims, the term “level” is meant to be understood broadly as any state of having a flat or even surface. In one example, a level surface may include an intended grade or slope of a surface.

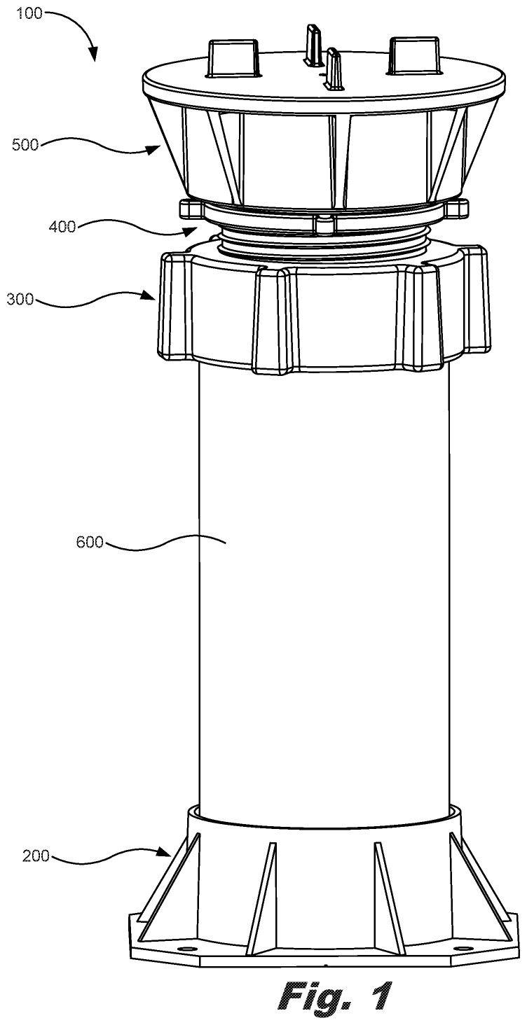

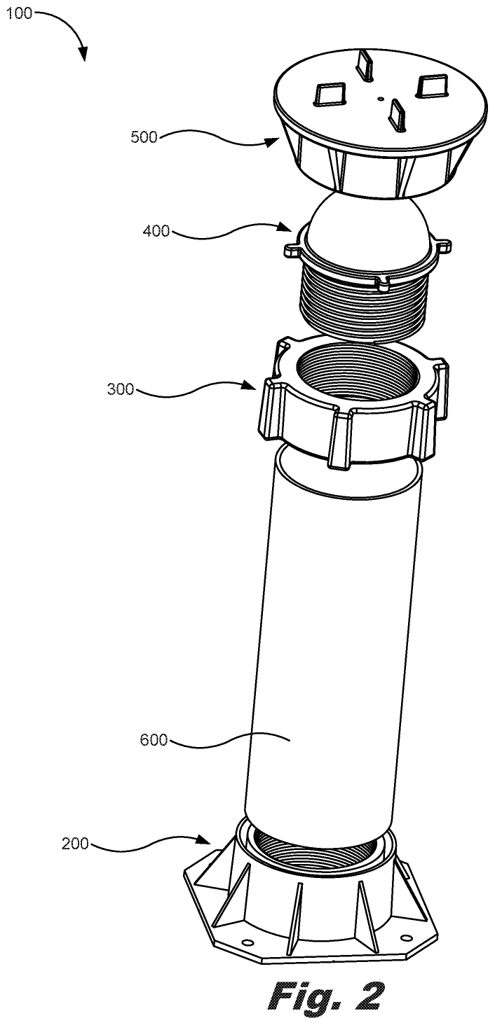

Turning now to the figures, FIG. 1 is an isometric view of a support (100), according to an example of the principles described herein. Further, FIG. 2 is an isometric, exploded view of the support (100), according to an example of the principles described herein. The support (100) may also be referred to herein as a floor jack. As described herein, the support (100) is used to support a floor or other substrate above an underlying subsurface or sub-floor. In one example, the subfloor may be uneven or unlevel, but it may be desirable for the raised floor to be supported by a plurality of the supports (100) such that the raised floor is level. Further, as described herein, the space provided between the subfloor and the raised floor may be used to accommodate utilitarian infrastructures such as electrical and communications wiring, plumbing, and gas lines among other utilities. Thus, a plurality of supports (100) may be used to support a plurality of tiles, pavers, or other sections or portions of the raised floor above the subfloor. The raised floor as supported by the supports (100) creates a hidden space between the raised floor and the subfloor structure of a building within which electrical or mechanical infrastructure may be located for easy future access.

Each support (100) may include a base (200), a threaded pillar (400), a pedestal (500), and a set coupler (300). Each of the base (200), threaded pillar (400), pedestal (500), and set coupler (300) are described individually in more detail herein. The support (100) also includes a length of piping (600) which will be described in more detail below. The base (200) abuts the subfloor on which the support (100) is placed. In one example, the threaded pillar (400) couples to the base (200) via, for example, mating threads (202, 402) used to convert between rotational and linear movement of the threaded pillar (400) relative to the base (200). The base (200) includes a female coupling comprising threads (202) that mate with the threads (402) of a male coupling of the threaded pillar (400).

The threaded pillar (400) also includes a domed top surface that interfaces with a corresponding concave portion of the pedestal (500). In this manner, the pedestal (500) articulates with respect to the threaded pillar (400). With this articulation of the pedestal (500) with respect to the threaded pillar (400), the support (100) may be used to level portions of the raised floor that are placed on the supports (100).

The support (100) may also include a set coupler (300). The set coupler (300) includes a ring with a female, threaded, interior cylinder that mates with the threads (402) of a male coupling of the threaded pillar (400). The set coupler (300), when coupled to the threaded pillar (400), sets the engagement of the threaded pillar relative to the base (200). More details regarding the base (200), the threaded pillar (400), the pedestal (500), and the set coupler (300) are described herein in connection with their respective figures.

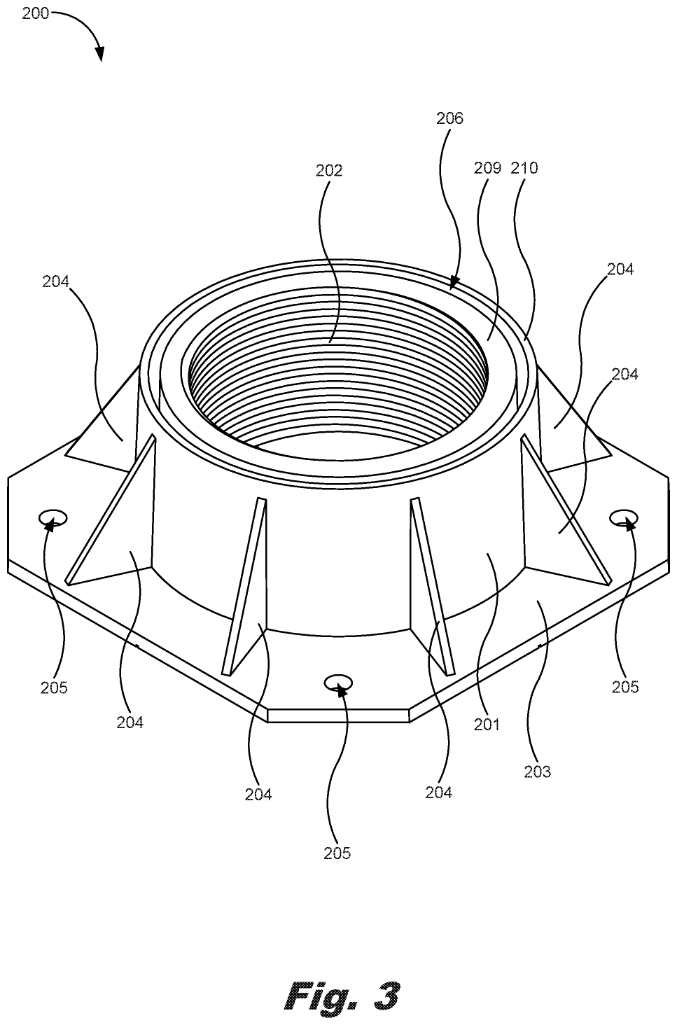

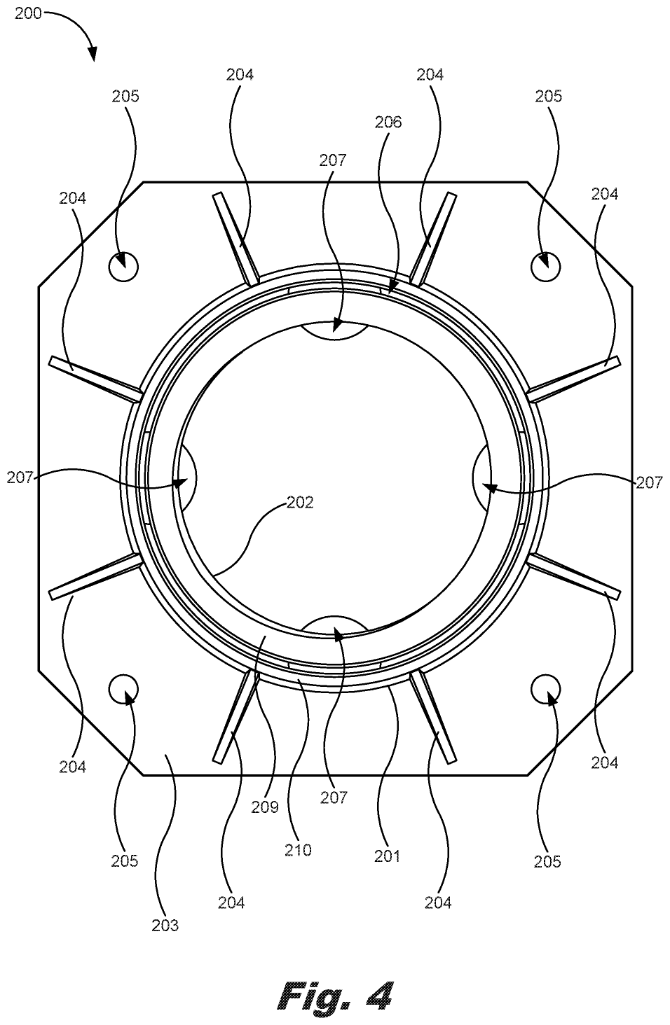

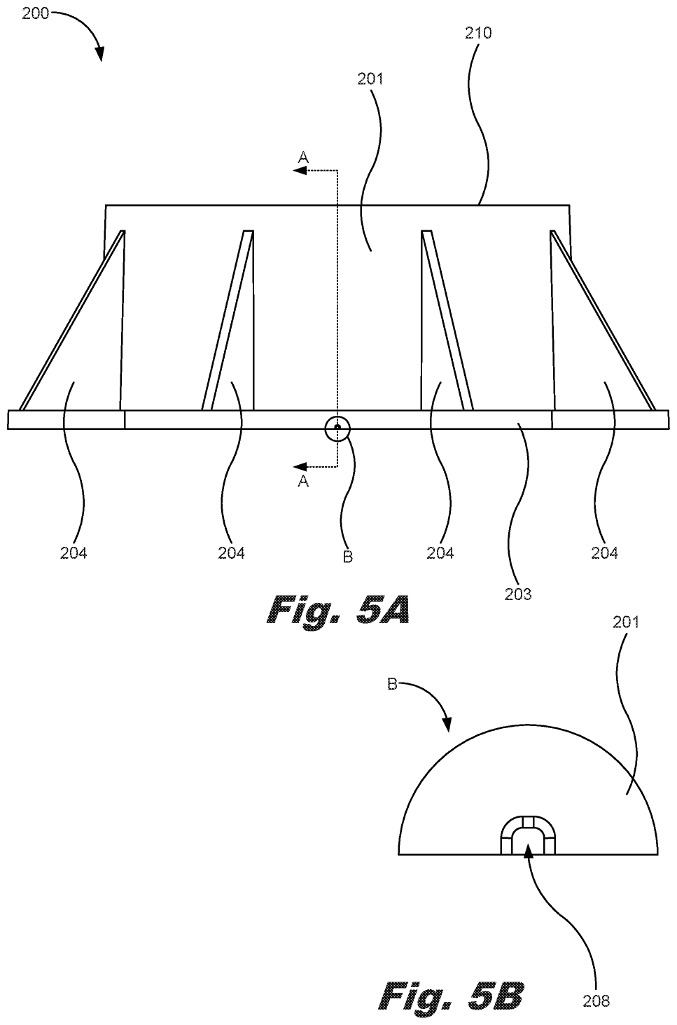

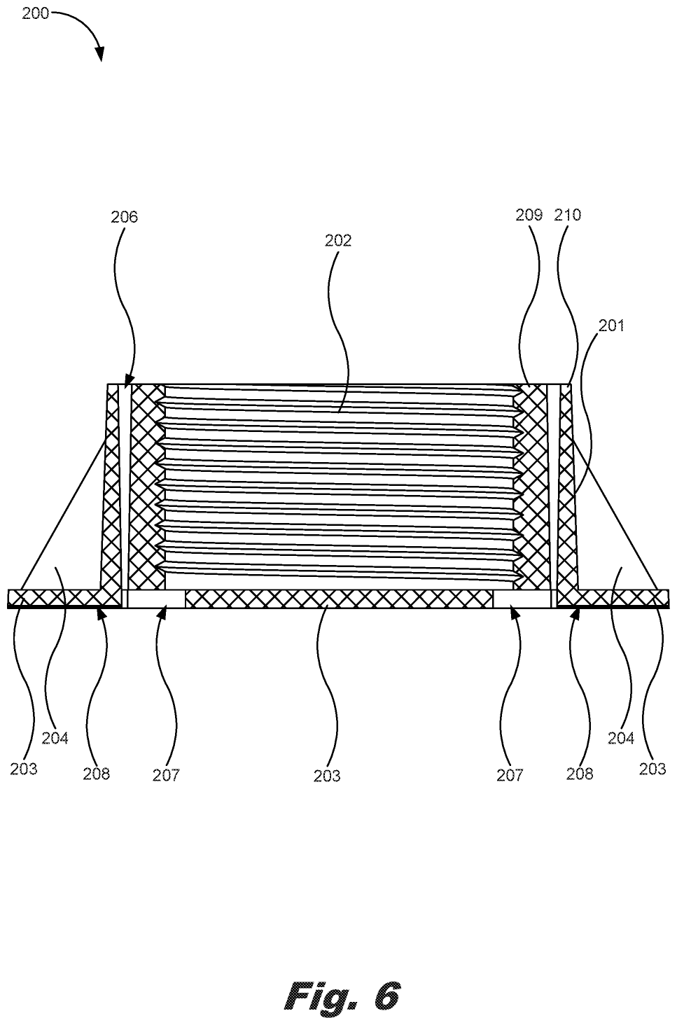

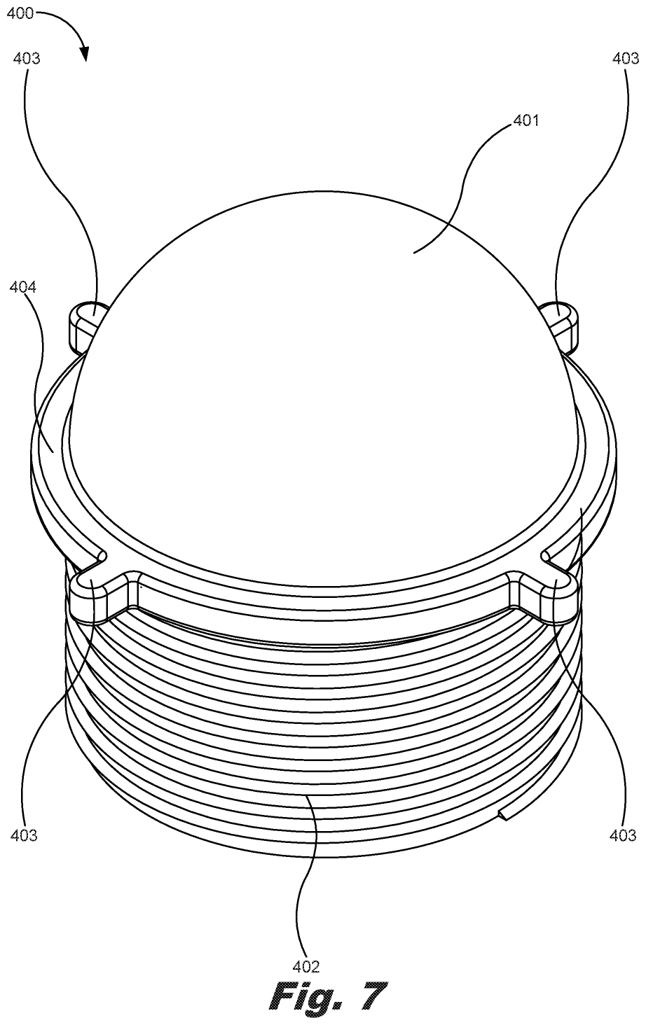

FIGS. 3 through 6 depict the base (200), FIG. 3 is a perspective view of the base (200) of the support (100), according to an example of the principles described herein. FIG. 4 is a top plane view of the base (200) of the support (100), according to an example of the principles described herein. FIG. 5A is a side plane view of the base (200) of the support (100), according to an example of the principles described herein. FIG. 5B is a side plane view of the base (200) of the support within circle B of FIG. 5A, according to an example of the principles described herein. Further, FIG. 6 is a side cutaway view of the base (200) of the support (100) along line A of FIG. 5A, according to an example of the principles described herein. The base (200) includes a cylinder (201) coupled to a substrate (203). The cylinder (201) is positioned perpendicularly to the substrate (203). Further, the cylinder (201) may include threads (202) that mate with corresponding threads (FIGS. 7, 9, and 10, 402) of the threaded pillar (400).

The base (200) may include a plurality of anchor voids (205) defined in the substrate (203). The anchor voids (205) are used to couple the base (200) to the subfloor Although the anchor voids (205) are depicted as being defined in the substrate (203), the base (200) may be coupled to the subfloor using other devices and methods including, for example, adhesives, any type of fastener, other fastening devices and methods, and combinations thereof.

The support (100) may include at least one rib (204) coupled between the substrate (203) and the cylinder (201). In the examples described herein, the support (100) includes eight ribs (204). However, the support (100) may include any number of ribs (204). The ribs (204) serve to buttress the cylinder (201) with respect to the substrate (203) such that any pressures or forces applied to the cylinder (201) in any direction including any off-axis pressure or force are supported by the ribs (204).

The base (200) may also include a pipe cavity (206) defined within the wall of the cylinder (201). Thus, the cylinder (201) may include an inner wall (209) and an outer wall (210) with the pipe cavity (206) dividing the inner wall (209) and the outer wall (210). The pipe cavity (206) is dimensioned to accept an annular edge of the length of piping (600). Thus, as depicted in FIG. 1, for example, the length of pipe (600) is coupled to the base (200) by fitting the length of pipe (600) within the pipe cavity (206). The length of pipe (600) serves to couple the base to the set coupler (300), and, therefore, to the threaded pillar (400) and pedestal (500).

As depicted in FIGS. 3 through 6, the pipe cavity (206) may run the height of the cylinder (201) at a number of portions along the circumference of the cylinder (201), and, in one example, may be formed within the base (200) to allow for fluid to flow through a number of fluid voids (207) as depicted in FIGS. 4 and 6, and weep ports (208) as depicted in FIGS. 5A and 5B to the exterior of the base (200). The fluid voids (207) are defined in and through the substrate (203) below the inner wall (209) and the outer wall (210) to allow the fluid to pool and exit the support (100) through the weep ports (208). A support (100) may be exposed to weather and elements since it may be installed and utilized outdoors. In this scenario, fluid such as rain water may be exposed to the support (100), and the fluid that may enter into the base through the space between the threads (202) or pipe cavity (206) of the cylinder (201) and the threads (FIGS. 7, 9, and 10, 402) of the threaded pillar (400). The fluid may flow, instead, into the pipe cavity (206), flow to the fluid voids (207), and exit the base (200) via the weep ports (208) defined in the outer wall (210) of the cylinder (201). In the example of FIGS. 3 through 6, four fluid voids (207) and four weep ports (208) are depicted. However, any number of fluid voids (207) and weep ports (208) may be included within the base (200).

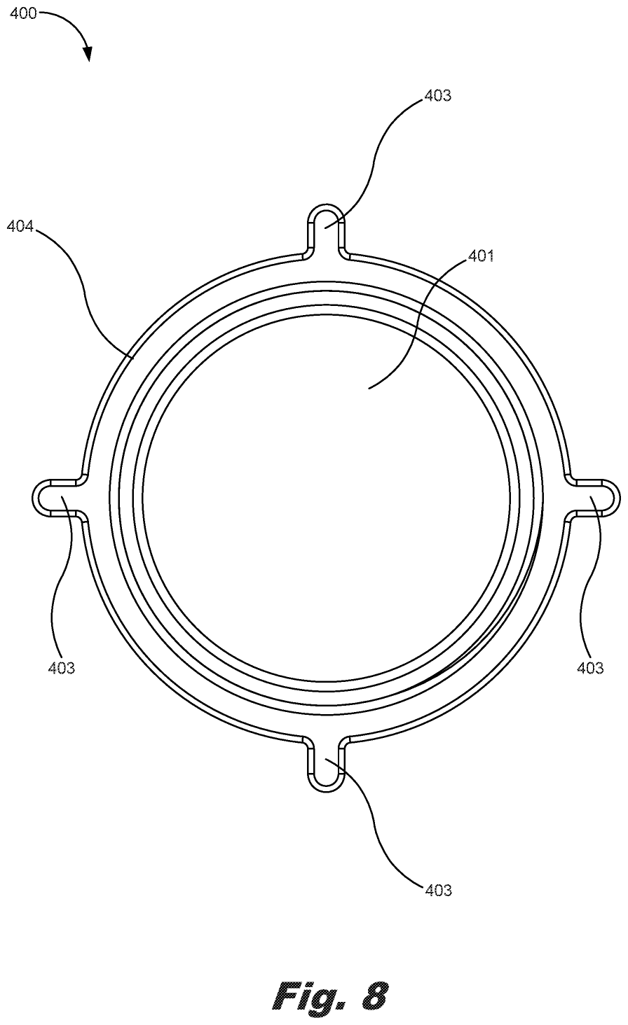

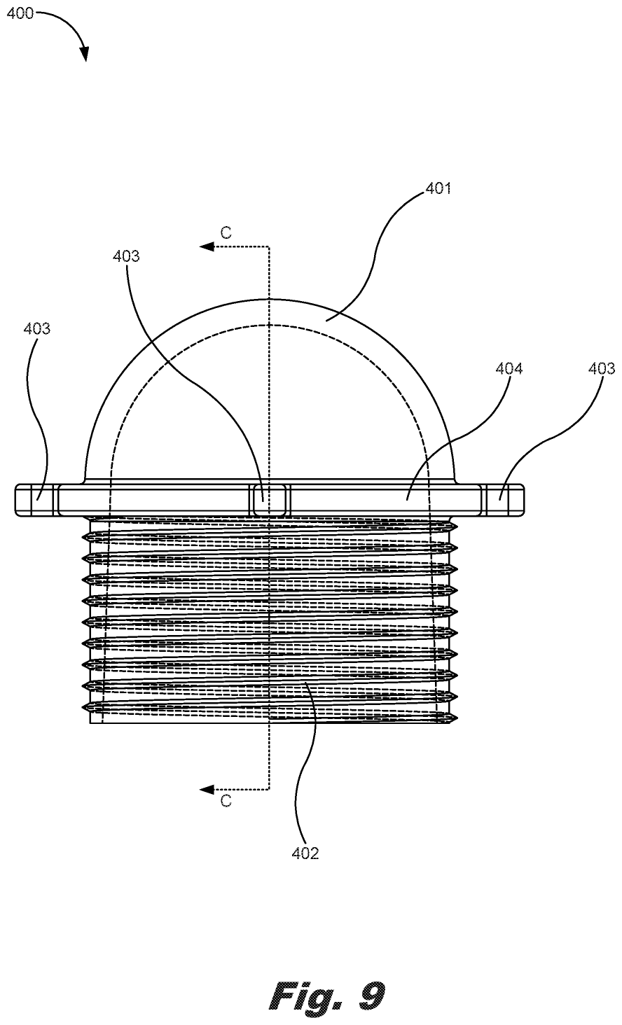

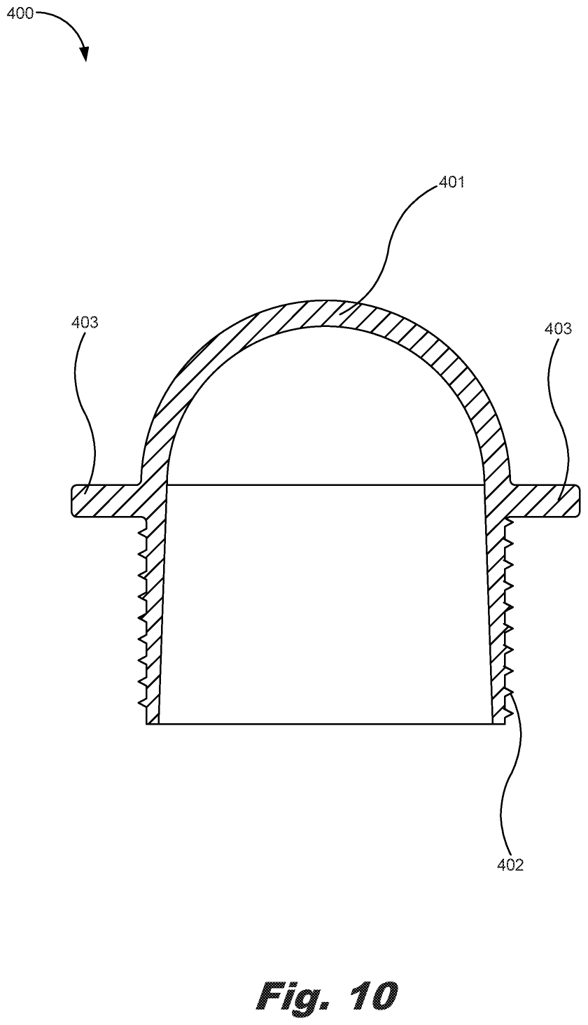

The threaded pillar (400) will now be described in connection with FIGS. 7 through 10. FIG. 7 is an isometric view of the threaded pillar (400) of the support (100), according to an example of the principles described herein. FIG. 8 is top plane view of the threaded pillar (400) of the support (100), according to an example of the principles described herein. FIG. 9 is side plane view of the threaded pillar (400) of the support (100), according to an example of the principles described herein. FIG. 10 is side cutaway view of the threaded pillar (400) of the support (100), according to an example of the principles described herein. Specifically, FIG. 10 is a side cutaway view of the threaded pillar (400) along line C of FIG. 9. The threaded pillar (400) may include threading (402) that mate with the threads (202) formed on the cylinder (201) of the base (200). When the threaded pillar (400) and the base (200) are threadingly coupled, this type of coupling allows for the height of the support (100) to be adjusted based on the degree at which the threads (202, 402) are interfacing. In this manner, the degree at which the threads (202, 402) are engaged allows the rotary motion of the threaded pillar (400) relative to the base (200) to be converted into linear motion that is used to set the height of the support (100). The ability to set the height of the support (100) in this manner allows for the ability to create a level raised floor with the tiles or other materials placed on the supports (100).

The threaded pillar (400) may include a number of protrusions (403) formed along a circumference of a band (404) formed between the threads (402) and a domed top surface (401) of the threaded pillar (400). The protrusions (403) serve to increase the grip of a user turning the threaded pillar (400) relative to the base (200) in order to raise or lower the height of the support (100) as described herein. Although the protrusions (403) are used as an example herein, any element that assists in the gripping of the band (404) to turn the threaded pillar (400) may be used including, for example, knurling, texturing, protrusions (403) with different shapes and form factors, other gripping elements, and combinations thereof.

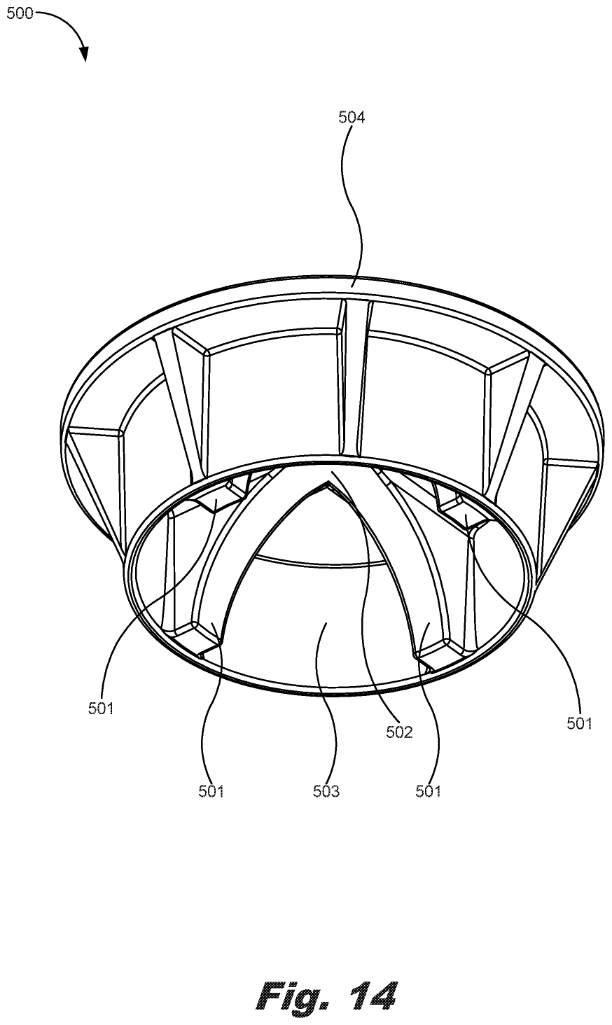

As described herein, the threaded pillar (400) may further include the domed top surface (401). The domed top surface (401) may include at least a portion of a sphere such as, for example, at least a portion of a hemisphere. As described in more detail herein, the domed top surface (401) may include a curvature and radius that matches an interior curvature and radius of arched vaults (501) of a pedestal (500) described in more detail in FIGS. 14 through 18. The articulation of the pedestal (500) with respect to the domed top surface (401) allows for the leveling of the pedestal (500) in order to level the raised floor that sits on the top of the pedestal (500). More details regarding the pedestal (500) are provided herein.

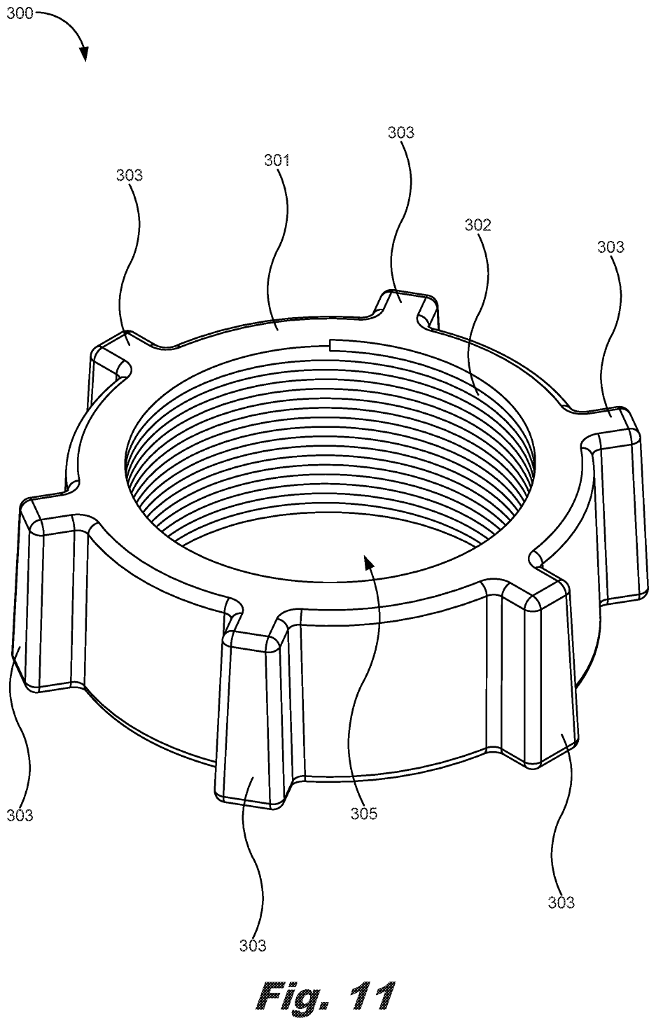

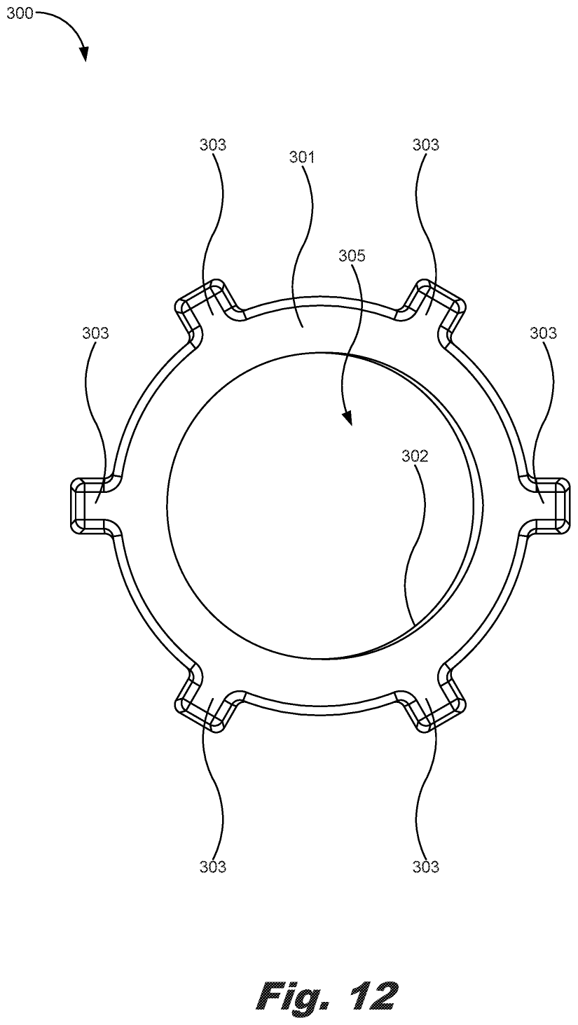

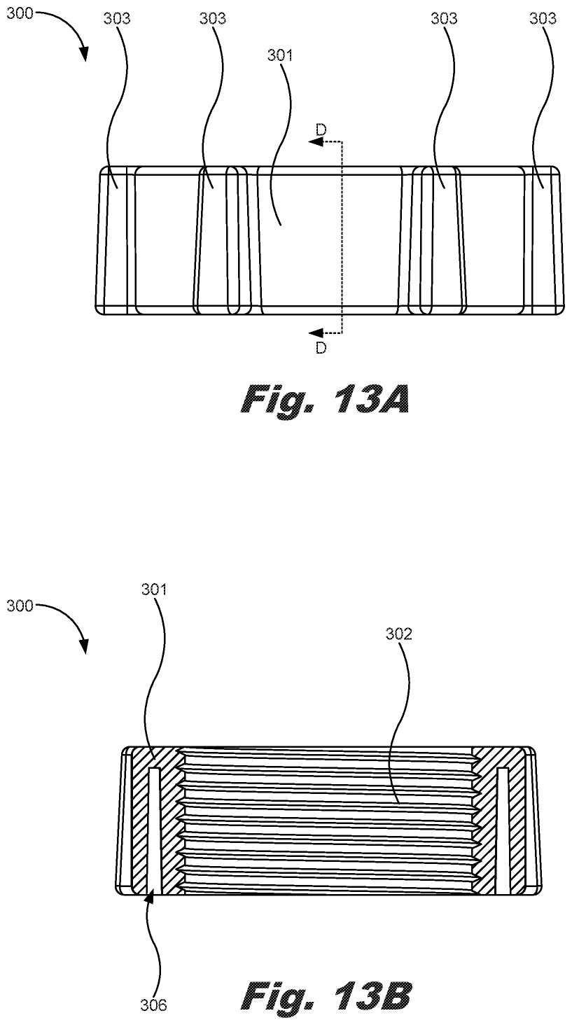

The set coupler (300) will now be described in connection with FIGS. 11 through 13B. FIG. 11 is an isometric view of the set coupler (300) of the support (100), according to an example of the principles described herein, FIG. 12 is top plane view of the set coupler (300) of the support (100), according to an example of the principles described herein. FIG. 13A is side plane view of the set coupler (300) of the support (100), according to an example of the principles described herein. FIG. 13B is side cutaway view of the set coupler (300) of the support (100), according to an example of the principles described herein. Specifically, FIG. 13B is a side cutaway view of the set coupler (300) along line D of FIG. 13A. The set coupler (300) is used as a type of “jam nut” where the set coupler (300) is “jammed” up against the top portion of the base (200) to lock the threaded pillar (400) in place relative to the base (200) in instances where the threaded pillar (400) directly couples with the base (200) and the piping (600) is not employed within the support (100). In this example, the base (200) acts as another bolt against which the set coupler (300) can abut. The purpose of the set coupler (300) is to ensure that the threaded pillar (400) does not turn relative to the base (200) so, in turn, the height of the support (100) cannot be adjusted until the set coupler (300) is disengaged from the base (200). The set coupler (300), when coupled to the threaded pillar (400), sets the engagement of the threaded pillar relative to the base. In contrast, when the piping (600) is used within the support (100), the set coupler couples to one end of the piping (600) in cavity (306), the base (200) couples to the other end of the piping (600) in cavity (206), and the threaded pillar (400) couples to the set coupler (300). More details regarding the use of the piping (600) within the support (100) are provided herein.

The set coupler (300) includes a ring body (301) with an interior cylindrical hole (305) that includes threads (302). The threads (302) mate with the threads (402) of the threaded pillar (400). In operation and in an example where the piping (600) is not used, the set coupler (300) is disengaged from the base (200) and twisted along the threads (402) of the threaded pillar (400) so that the set coupler (300) no longer abuts the base (200). In this state, the threaded pillar (400) can turn with respect to the base (200) using the threads (202, 402) of the base (200) and the threaded pillar (400), respectively. Once the threaded pillar (400) is set at a desired height with respect to the base (200), the set coupler (300) may be twisted down the threads (402) of the threaded pillar (400) to abut the base (200). In this manner, the threaded pillar (400) is set, and the ability of the threaded pillar (400) to move relative to the base (200) is restricted.

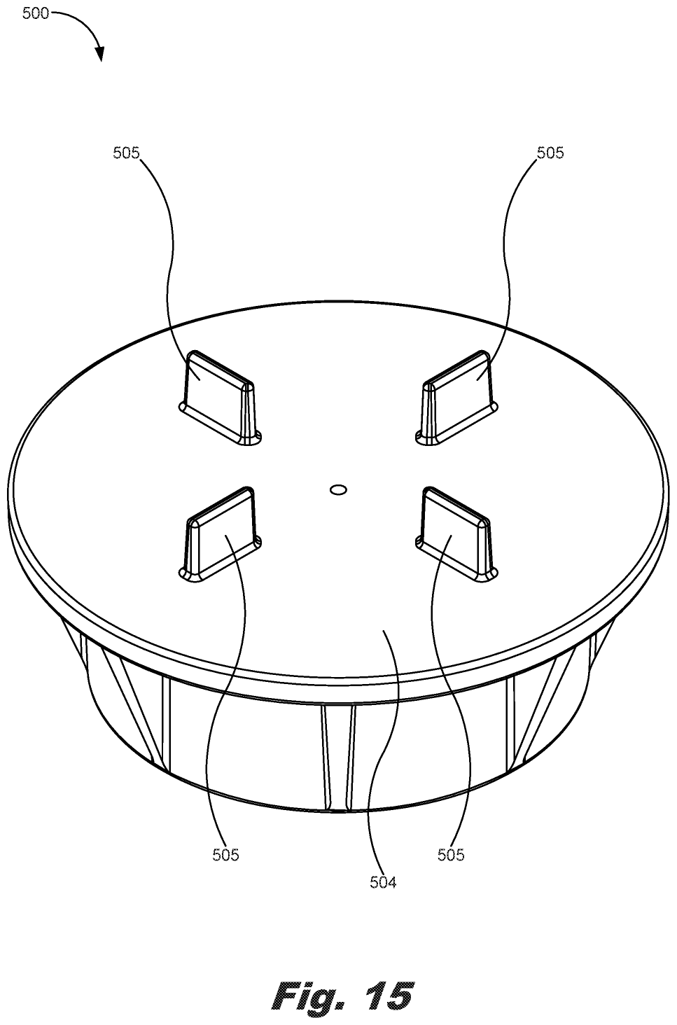

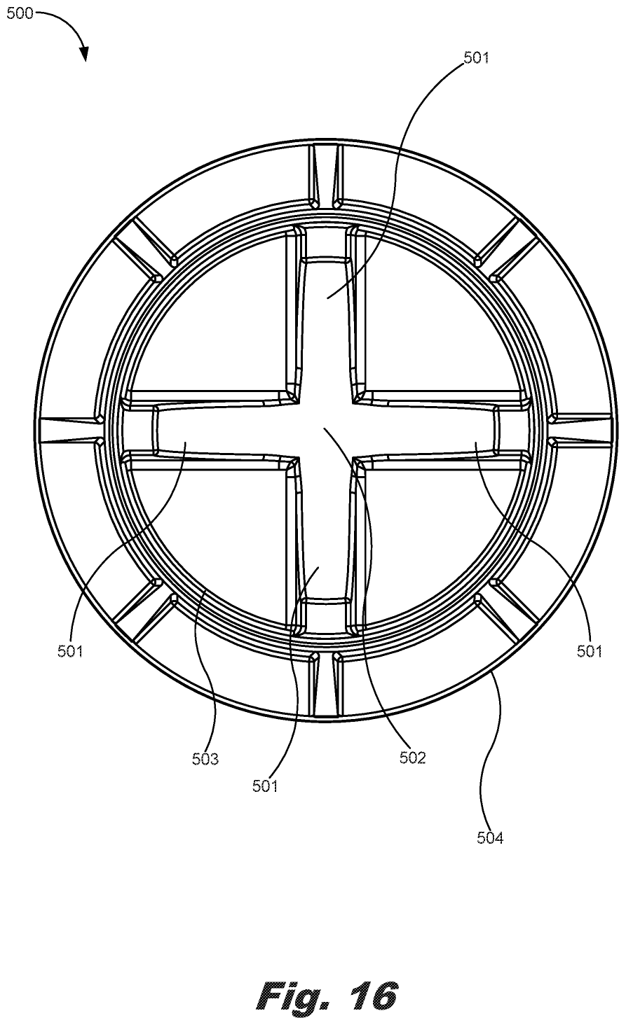

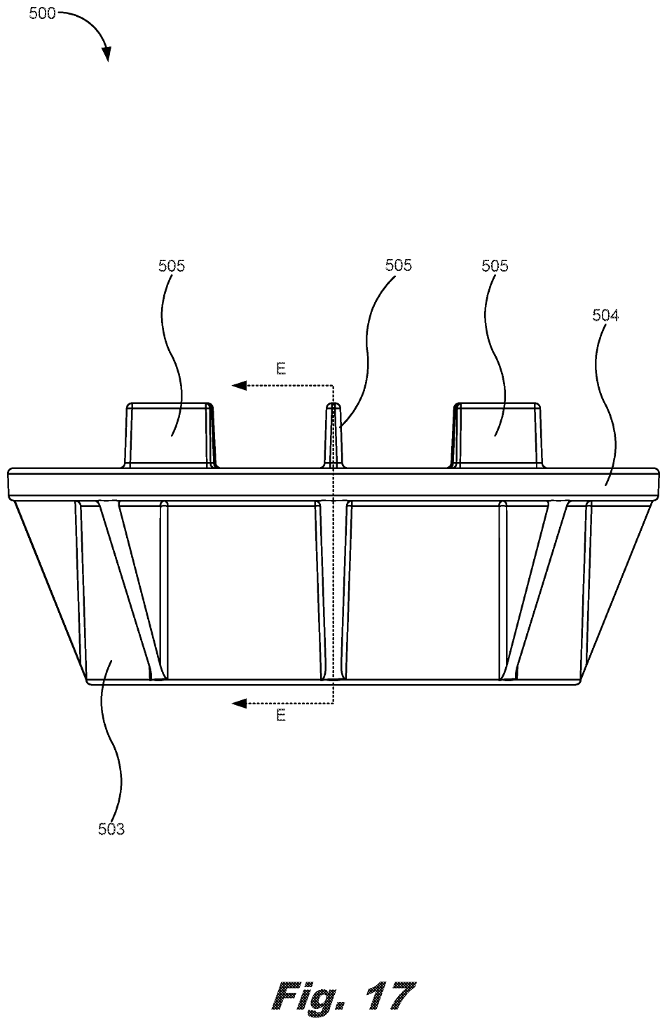

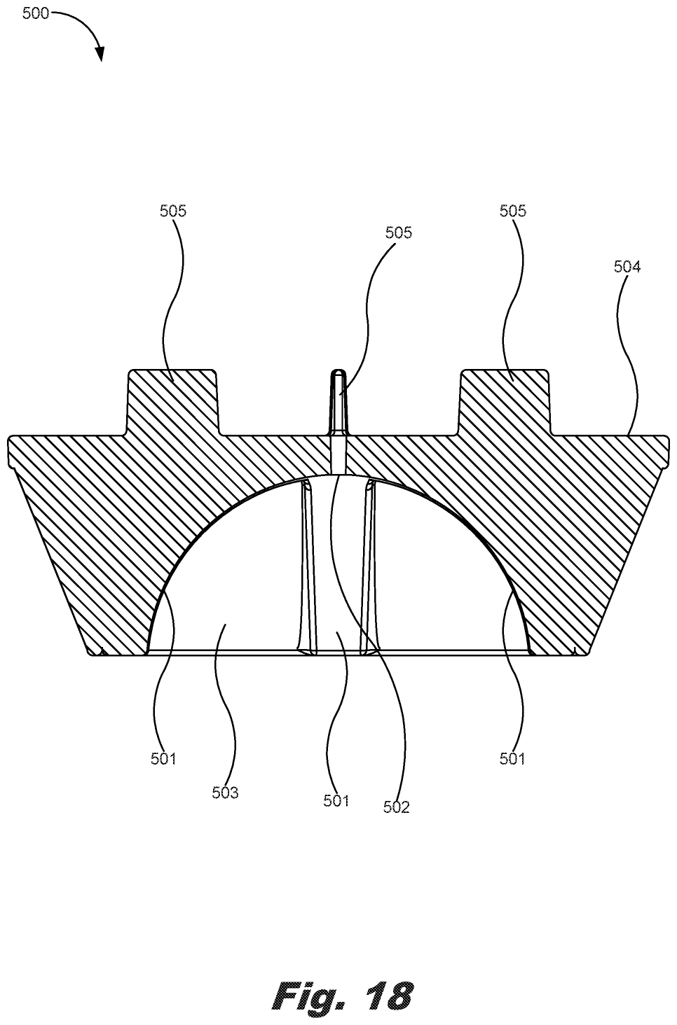

FIGS. 14 through 18 depict the pedestal (500). FIG. 14 is an isometric bottom view of the pedestal (500) of the support (100), according to an example of the principles described herein. FIG. 15 is an isometric top view of the pedestal (500) of the support (100), according to an example of the principles described herein. FIG. 16 is bottom plane view of the pedestal (500) of the support (100), according to an example of the principles described herein. FIG. 17 is side plane view of the pedestal (500) of the support (100), according to an example of the principles described herein. FIG. 18 is side cutaway view of the pedestal (500) of the support (100), according to an example of the principles described herein. Specifically, FIG. 18 is a side cutaway view of the pedestal (500) along line E of FIG. 17. The pedestal (500) articulates relative to the threaded pillar (400) through the interface of the domed top surface (401) of the threaded pillar (400) with a mating concave portion of the pedestal (500). The concave portion of the pedestal (500) includes a number of intersecting, arched vaults (501) that meet at an apex (502). The curvature of each of the arched vaults (501) matches the curvature of the domed top surface (401) of the threaded pillar (400) so that the pedestal (500) may move over the domed top surface (401) of the threaded pillar (400) in order to level the pedestal (500) as flooring or other portions of the raised floor are placed on top of the pedestal (500) of the support (100).

The arched vaults (501) are circumscribed within a cylinder (503), and the cylinder (503) and arched vaults (501) are formed with or otherwise coupled to a top portion (504). The top portion (504) of the pedestal (500) may include a number of datum (505) formed thereon. The datum (505) serve to align and space flooring such as tile that is placed on top of the support (100). In one example, the datum (505) may be arranged on the top portion (504) of the pedestal (500) in coordinate directions as depicted in FIGS. 15, 17, and 18. However, the datum (505) may be formed on the top portion (504) in any arrangement and in any number that assists in the alignment and arrangement of the flooring on top of the support (100). In one example, the flooring used in connection with the support (100) may include voids formed therein that are space, arranged, and interface with the datum (505). Further, in one example, the datum (505) may not be included as a part of the top portion (504) of the pedestal (500). In this example, the tiles or other elements of the raised floor may be placed along the surface of the top portion (504) and supported by the pedestal (500) without the assistance of the datum (505).

Having described the support (100) along with its base (200), threaded pillar (400), set coupler (300), and pedestal (500), reference is now made to FIGS. 1 through 18. When deploying the support (100) a user may couple the set coupler (300) to the threaded pillar (400) by engaging the threads (302) of the set coupler (300) with the threads (402) of the threaded pillar (400). The set coupler (300) may be threaded up to the band (404) of the threaded pillar (400) so that the set coupler (300) is clear of the bottom portion of the threads (402) of the threaded pillar (400). In this state, the threads (402) of the threaded pillar (400) may be exposed to engage with the threads (202) of the base (200).

In one example, once the pedestal (500) has been leveled or adjusted as appropriate relative to the threaded pillar (400), the pedestal (500) and the domed top surface (401) of the threaded pillar (400) may be coupled to one another to restrict the movement of the pedestal (500) relative to the threaded pillar (400). For example, in one example where the threaded pillar (400) and pedestal (500) are formed from a plastic, the threaded pillar (400) and pedestal (500) may be coupled together using plastic welding processes. In another example where the threaded pillar (400) and pedestal (500) are formed from a polyvinyl chloride (PVC), the threaded pillar (400) and pedestal (500) may be chemically welded to one another using a PVC glue. However, in an example, the pedestal (500) may be allowed to remain as an articulating element relative to the threaded pillar (400).

Turning again to FIGS. 1 through 6 and 11 through 13B, a length of piping (600) may be coupled between the base (200) and the set coupler (300). In one example, the piping (600) may be affixed to the base (200) by inserting the annular end of the piping into the pipe cavity (206) defined between the inner wall (209) and the outer wall (210). In one example, the piping (600) and the base (200), once coupled, may be chemically welded to one another using a PVC glue, or may be coupled using some other mechanical method such as press fitting the piping (600) into the pipe cavity (206) of the base (200). Similarly, in this example, the piping (600) may be coupled to the set coupler (300) by inserting the piping into a piping channel (306) defined in the ring body (301) of the set coupler (300). Again, in one example, the piping (600) and the set coupler (300), once coupled, may be chemically welded to one another using a PVC glue, or may be coupled using some other mechanical method such as press fitting the piping (600) into the piping channel (306) of the set coupler base (300). In examples where the piping (600) is not used in the support (100), the pipe cavity (206) is used to direct fluids way from the support (100).

In one example, the piping (600) may be any length to provide a coarse or rough distance between the subfloor and an intended height of the top of the pedestal (500) of the support (100). The threaded pillar (400), interfacing with the set coupler (300) via the threads (402) of the threaded pillar (400) and the threads (302) of the set coupler (300), may be turned relative to the set coupler (300) to create a fine adjustment of the height of the support (100). In this manner, the height of the support (100) may provide a greater range of heights with the piping in place than otherwise. Further, in one example where multiple supports (100) are used to support the raised floor, some of the supports (100) may utilize the piping (600) while other supports (100) may not depending on the slope and levelness of the subfloor, and the degree at which the raised floor is to be level relative to the subfloor.

The specification and figures describe a floor jack or support. The support may include a base, and a threaded pillar threadingly coupled to the base. The threaded pillar may include a dome top surface. The floor jack may also include a pedestal. the pedestal may include concave portion, and the concave portion may include a mating curvature relative to the dome top surface of the threaded pillar. This support may provide for an easy way to level a raised floor or support another element in a level manner. Further, the support provides for a way to support the raised floor or other element in at a rough distance through implementation of the piping, while still providing a way to finely adjust the height of the support through the use of the pedestal threadingly coupled to the base.

The preceding description has been presented to illustrate and describe examples of the principles described. This description is not intended to be exhaustive or to limit these principles to any precise form disclosed. Many modifications and variations are possible in light of the above teaching.

What is claimed is:

1. A floor jack comprising:
a base;
a threaded pillar threadingly coupled to the base, the threaded pillar comprising a dome top surface; and
a pedestal comprising a concave portion, the concave portion comprising a mating curvature relative to the dome top surface of the threaded pillar.

2. The floor jack of claim 1, wherein leveling of an article placed on the floor jack is achieved through the relative articulation of the concave portion of the pedestal to the dome top of the threaded pillar.

3. The floor jack of claim 1, comprises at least one fluid aperture to allow fluid to escape an interior of the base.

4. The floor jack of claim 1, wherein the dome top comprises at least a portion of a surface of a sphere.

5. The floor jack of claim 1, wherein the threaded pillar comprises a number of protrusions to facilitate the turning of the threaded pillar relative to the base to engage the threads of the threaded pillar and mating threads of the base.

6. The floor jack of claim 5, wherein turning of the threaded pillar relative to the base adjusts the height of the floor jack.

7. The floor jack of claim 1, comprising a set coupler threadingly coupled to the threaded pillar, the set coupler to set the engagement of the threaded pillar relative to the base.

8. The floor jack of claim 1, wherein the set coupler comprises a number of flanges to facilitate in rotation of the set coupler about the threaded pillar.

9. The floor jack of claim 1, wherein the pedestal comprises a number of datum to align substrates placed on the pedestal.

10. The floor jack of claim 7, comprising a length of piping coupled between the base and the set coupler.

11. A support comprising:
a base comprising a threaded interior channel;
a threaded pillar comprising:
a threaded exterior cylinder to threadingly couple to the base; and
a domed top;
a pedestal comprising a concave portion, the concave portion comprising a mating curvature relative to the dome top of the threaded pillar; and
a set coupler threadingly coupled to the threaded pillar.

12. The support of claim 11, wherein the set coupler sets the engagement of the threaded pillar relative to the base based on the location of the set coupler along the length of the threaded exterior cylinder of the threaded pillar.

13. The support of claim 11, wherein the relative articulation of the concave portion of the pedestal to the dome top of the threaded pillar levels an article placed on the support.

14. The support of claim 11, comprising a length of piping coupled between the base and the set coupler.

15. The support of claim 11, wherein the dome top comprises at least a portion of a surface of a sphere.

16. The support of claim 11, wherein the threaded pillar comprises a number of protrusions to facilitate the turning of the threaded pillar relative to the base to engage the threads of the threaded pillar and mating threads of the base.

17. The support of claim 16, wherein turning of the threaded pillar relative to the base adjusts the height of the support.

18. The support of claim 11, wherein the set coupler comprises a number of flanges to facilitate in rotation of the set coupler about the threaded pillar.

19. The support of claim 11, wherein the pedestal comprises a number of alignment protrusions to align substrates placed on the pedestal.

20. The support of claim 11, wherein the base comprises a number of anchor voids to anchor the base to a surface.
